(19) United States
(12) Patent Application Publication
(10) Pub. No.: US 2010/0325136 A1
(43) Pub. Date: Dec. 23, 2010

(54) ERROR TOLERANT AUTOCOMPLETION

(75) Inventors: Surajit Chaudhuri, Redmond, WA (US); Shriraghav Kaushik, Bellevue, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/490,288

(22) Filed: Jun. 23, 2009

(51) Int. Cl. G06F 17/30; G06F 3/048

(52) U.S. Cl. 707/759; 715/780; 707/776; 707/769

(57) ABSTRACT

Techniques for error-tolerant autocompletion are described. While displaying characters of an input string as they are inputted by a user, when a character is added to the input string by the user, matching strings may be selected from among a set of candidate strings by determining which of the candidate strings have a prefix whose characters match the characters of the input string within a given edit distance of the input string.

### BACKGROUND

Autocompletion is a ubiquitous feature useful in many environments and applications. As a user types text in a computing device, an Autocompletion feature may generate a list of appropriate completions of the currently typed text. Autocompletion may have different goals for users, for example, reducing the amount of text that needs to be typed or guiding a user's typing. Autocompletion is implemented in program editors such as Visual Studio, command shells such as the Unix Shell, search engines such as Google, Live, and Yahoo, and desktop search facilities. Autocompletion is also gaining popularity for mobile devices where it can assist users in keying in contacts and text messages. Autocompletion is also used with databases to help ensure data integrity by substantially reducing the probability of data entry errors.

A specific scenario for using autocompletion involves a user is looking up a record from a table by entering a string. For example, when a sales clerk is looking up a customer's name or looking up a product catalog online. The Amazon.com website suggests completions when a user is looking up a product item. Similarly, Yahoo Finance suggests completions when a user is looking for a stock symbol or organization name.

Autocompletion has been viewed in two ways. Online autocompletion may entail performing exact matching, because without autocompletion a user would have to type out the string in its entirety and then match it against the table of records. In contrast to the online autocompletion process, inexact or approximate string matching may be referred to as offline autocompletion.

Techniques related to error-tolerant autocompletion are discussed below.

### SUMMARY

The following summary is included only to introduce some concepts discussed in the Detailed Description below. This summary is not comprehensive and is not intended to delineate the scope of the claimed subject matter, which is set forth by the claims presented at the end.

Techniques for error-tolerant autocompletion are described. While displaying characters of an input string as they are inputted by a user, when a character is added to the input string by the user, matching strings may be selected from among a set of candidate strings by determining which of the candidate strings have a prefix whose characters match the characters of the input string within a given edit distance of the input string.

Many of the attendant features will be explained below with reference to the following detailed description considered in connection with the accompanying drawings.

### BRIEF DESCRIPTION OF THE DRAWINGS

The present description will be better understood from the following detailed description read in light of the accompanying drawings, wherein like reference numerals are used to designate like parts in the accompanying description.

FIG. 1 shows an example use of autocompletion.

FIG. 2 shows a process for using edit distance to perform error-tolerant autocompletion.

FIG. 3 shows a dynamic programming matrix 180 for two example strings.

FIG. 4 shows a matrix.

FIG. 5 shows an algorithm for performing error-tolerant autocompletion.

FIG. 6 shows example autocompletion candidates.

FIG. 7 shows a trie-based algorithm.

FIGS. 8 and 9 shows example tries.

FIG. 10 shows an algorithm for setting an appropriate transition length.

### DETAILED DESCRIPTION

### Overview

Embodiments discussed below relate to extending autocompletion to tolerate errors and differences in representation. Consider the name Schwarzenegger. It is likely that a user looking up this name will start with typing the prefix Shwarz or Swarz instead of the correct prefix Schwarz. In this case, exact autocompletion suggests based on correct completion are only possible when the prefix S has been entered. However, at that point, in a realistic database, there will most likely be too many completions (strings starting with S) for practical use. This problem may be exacerbated in domains such as product model numbers where phonetics and intuition cannot be relied on to guess the correct spelling. Furthermore, a user may mistype a string even when the correct spelling is known. Such typing errors are presumably as likely to occur at the beginning of the string as anywhere else. As will be seen, error-tolerant autocompletion might be helpful to address these problems and others.

The following description begins with explanation of a framework for exact autocompletion. The next section extends the autocompletion framework to tolerate errors. As exact autocompletion may be viewed as an online version of exact lookup, the error-tolerant autocompletion problem may be modeled as an online version of error-tolerant lookup. As is in the field of data cleaning, error toleration may be understood in terms of string similarity. While any known techniques for modeling string errors may be used, edit distance will be used as an example method of measuring similarity between strings. It is then shown that it is possible to implement this strategy by using any generic edit distance matching algorithm at each step. Due to possible expense of this approach, two edit-tolerant autocompletion algorithms are described. The first is based on the state-of-the-art q-gram based edit distance matching algorithms. The second is a trie-based algorithm.

### Autocompletion Overview

In some uses, autocompletion involves suggesting valid completions of a partially entered lookup string with the intention of minimizing and guiding the user's typing. In some autocompletion scenarios there is a table T of strings being looked up and completions are suggested based on matches in T. Some general concepts involved in exact autocompletion are discussed next.

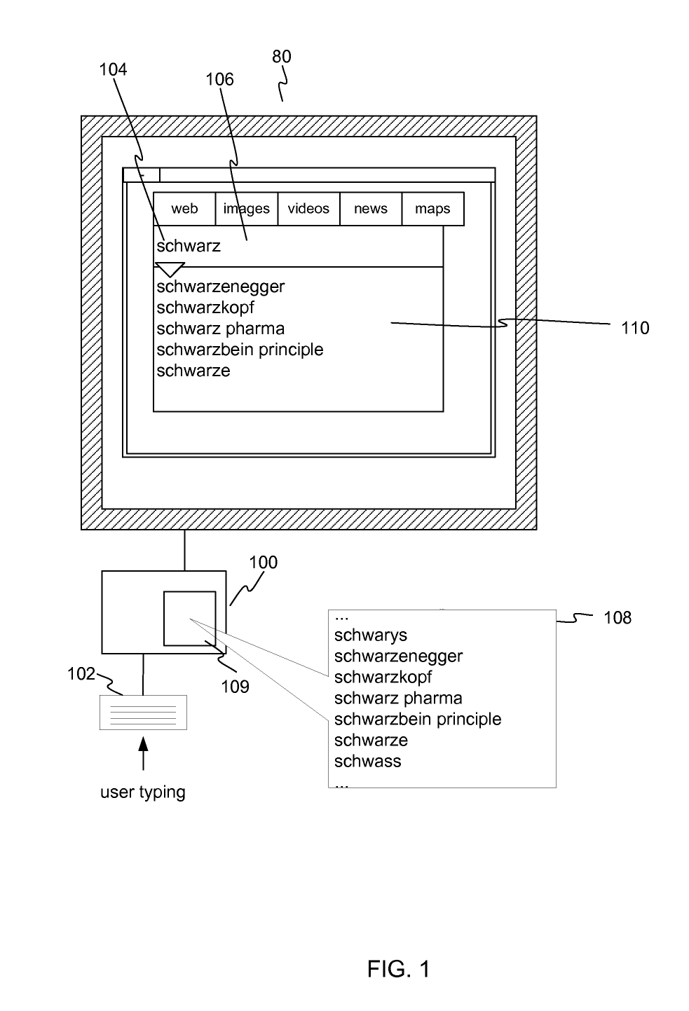

FIG. 1 shows an example use of autocompletion. A display 80 may be connected to a computing device 100 (e.g., a desktop workstation, a mobile device, a laptop, etc.), which may have a processor, memory, storage, etc. The computing device 100 may be displaying an application 101 (e.g., text editor, web browser, data entry program, etc.). The computing device 100 has an input device 102 such as a keyboard, microphone (for voice-text recognition), a mouse, stylus, etc. A user uses the input device 102 to input a text string 104, which might be displayed in a text input box 106 or the like. As characters are entered (or deleted, inserted, etc.), the computing device 100, which is storing a dictionary, set, or table 108 of strings in memory 109 repeatedly selects from the table 108 strings that have a prefix that matches (or, as described herein, nearly matches) the input string 104. A drop down menu 110 may be used to display matching autocompletion strings which the user may interactively select to set as the input string 104. Other uses of autocompletion are known and the case above is only an illustrative example.

### Autocompletion Interface

Autocompletion may be an online problem where at any point there is a partially typed string s, called the lookup string. In response to typing, autocompletion processing produces a list Completions(s). The lookup string is modified via some user move, for example appending, inserting, or deleting a character at any point in the string, choosing a suggested completion, or invoking a lookup operation. Discussion herein focuses on common moves: Append(c), where a character is appended to the end of the lookup string s; and Choose(s')where s′ε Completions(s) and one of the suggested completions is chosen.

### Autocompletion Strategy

To help explain error-tolerant autocompletion, exact autocompletion will be discussed. Exact autocompletion strategies are ways in which exact autocompletion may be performed. A simple strategy is to return all strings in T that are extensions of the lookup string. When the number of characters in the lookup string is small the number of extensions can be too large to be useful. An alternate strategy is to perform autocompletion after a minimum number of characters have been input. Another exact autocompletion approach is to return, at each point, all strings in T that contain the partially entered lookup string as a substring. In general, the autocompletion strategy can be highly complex. For example, completions can be ordered by leveraging an application specific static score assigned to each string in T. For example, if T represents a table of products lookup queries posed against T are logged, the static score can be used to reflect the popularity of a product based on the number of recent purchases, for instance. Alternately, the static score can be used to bias the lookup toward newer products. Another example is when T consists of author names the static score is used to reflect the subject area, then an application that is targeted toward database users can use the static score to assign a preference to database authors.

A fixed autocompletion strategy can be supported by a variety of algorithms. For instance, if the strategy is to return all extensions of the lookup string, it is possible to (i) at each point issue an offline prefix lookup using a B-Tree that finds all extensions in T, or (ii) use a trie to find all extensions in an online fashion.

### Incorporating Error Tolerance

In general, any of the autocompletion methods mentioned earlier can be extended to be error-tolerant. Error tolerance can be achieved in many ways, for example by choosing different similarity functions, a variety of which can be used to make autocompletion error-tolerant. Techniques described herein extend the prefix based autocompletion approach to be error tolerant. In one embodiment, the classic edit distance function is used as the similarity function, although the techniques also generalize to handle substring matching.

A definition of edit distance of edit distance will be provided in the next section. The following section discusses modification of the concept of string extensions to tolerate string edits via the notion of k-Extensions. In the next section, properties of k-Extensions will be described, which will be followed by a section on a basic baseline algorithm for error-tolerant autocompletion.

### Edit Distance Based Matching

Edit distance is used herein to enable error toleration when performing autocompletion. Given two strings s1 and s2, edits may be operations such as insertion and deletion of a character as well as replacement of one character with another. Each of these moves has a cost or distance of 1. The minimum number of moves to perform on s1 such that the result is equal to s2 is the edit distance between the strings, denoted ed(s1, s2). The phrase “edit distance within k” will be used to refer to the expression ed(s1, s2)≦k. For a string s and a threshold k, the (offline) edit lookup operation returns all strings r ε T that are within edit distance k in increasing order of edit distance.

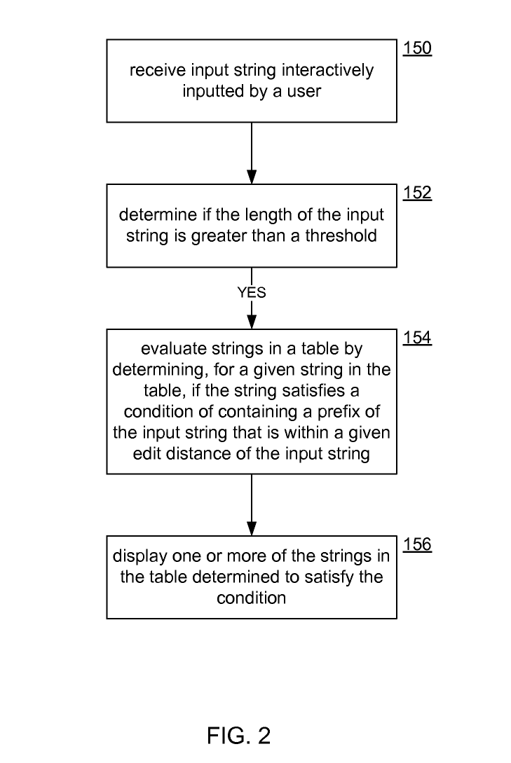

FIG. 2 shows a process for using edit distance to perform error-tolerant autocompletion. An input string, e.g., “shw”, is received as inputted by a user, for example, using a keyboard, stylus and letter palette, dictation and text recognition, etc. Optionally, it may be determined 152 if the length of the input string is greater than a threshold, for example, two. When strings are short, there may be too many matches for meaningful selection. Assuming that a table of candidate strings is available, strings therein are evaluated 154. For a given candidate string in the table, evaluating may involve determining if the string satisfies a condition of containing a prefix of the input string that is within a given edit distance of the input string. For example, if the edit distance is one and the input string is “shw”, then “ashwin navin”, “schwarz, hermann”, and “schwarzenegger, arnold” would each satisfy the condition, because each contains a prefix (“ashw”, “schw”, “schw”) of the input string that is an edit distance of one from the input string. One or more of the strings determined to satisfy the condition are displayed 156 for the user, and optionally the user is allowed to select one of the displayed 156 strings to replace the input string.

When only a few characters of a lookup string have been entered, there may be too many completions for autocompletion to be useful. A buffered strategy, described below, may be used that increases the edit distance threshold after a few input characters have been entered. Except for a “transition” point where the edit threshold increases, online trie-based algorithms may be used. Pre-computation may be used to handle the transition. By hashing characters to a small number of bits and exploiting the fact that pre-computation is performed for short strings, the amount of state needed for pre-computation can be controlled.

Often, the strings in the table being looked up have an application specific static score (e.g., relevancy, document or general frequency statistics, recency metrics, etc.). For example, in a table of product records, the static score could be used to reflect the popularity of a product based on the number of recent purchases. This may be factored in addition to the edit distance in ordering the autocompletion output. It will be shown below how to extend algorithms described herein to return only the top-I extensions.

### K-Extension

The concept of string extensions is now extended to tolerance of errors or string edits. First, a string si is defined to be a “k-prefix” of string s2, denoted s1<^{k} s2 if there is some extension of s1 that is within edit distance k of s2. String s2 is called a “k-extension” of s1. The smallest k such that s2 is a k-extension of s1 is called the extension distance of s2 given s1.

Referring again to the example mentioned above with reference to FIG. 2, each of the strings “ashwin navin”, “schwarzenegger, arnold”, and “schwarz, hermann” is a 1-extension of input string “shw”. The extension of the input string that yields edit distance 1 to “Schwarzenegger” is “shwarzenegger”. The extension distance of “Schwarzenegger” given “shwarz” is 1. If instead of using string extensions edit-tolerant substring matching were used, then in FIG. 2 additional strings such as “graeme swann” would have been returned.

A strategy for using k-extension will now be explained (with details to be provided later). First, assume an edit threshold k. A k-extension technique is to: at each point at which the lookup string is modified by the user appending characters, try to return all k-extension in order of increasing extension distance.

When only a few characters of the lookup string have been entered extensions may outnumber exact autocomplete matches. Also, a large edit distance may not be needed when few characters of the lookup string have been typed. Therefore, a buffered strategy may be used; the k-extensions are returned after the lookup string has a minimum number of characters. This number will be referred to as the transition length.

Further to the k-extension strategy, a specific static score associated with each string in the lookup table T may be used, if available. A scoring function may be monotonic in both edit distance and static. Completions can be returned ordered by the scoring function and independent of the specific function, so long as the function is monotonic.

### Properties of K-Extensions

To help understand k-extensions, the relationship between extensions and prefixes will be discussed. This relationship is used to show how to compute the pairwise extension distance defined above by adapting the classic edit distance computation algorithm, which is a dynamic programming algorithm (see G. Navarro, “A guided tour to approximate string matching”, ACM Computing Surveys, 33(1):31-88, 2001).

Regarding the relationship between extensions and prefixes, the following equivalence forms a basis for algorithms (q-gram based and trie based) described later. Property 1: String s1 may be a k-prefix of s2 (s1<^{k}s2) if and only if there is some prefix s2′ of s2 such that s1 and s2′ are with edit distance k. To illustrate, the string “schwarzenegger” is a 1-extension of “shwarz”. In this case, the prefix “schwarz” is within edit distance 1 of “shwarz”.

An algorithm to solve pairwise extension distance will be explained by first considering the basic problems of extension edit distance (an edit distance of string s2 given string s1) and k-extension distance (given s1 and s2, if the extension distance of s2 given s1 is at most k, then compute the extension edit distance).

These problems can be solved by an adaptation of the standard dynamic programming algorithm mentioned above, which is reviewed next.

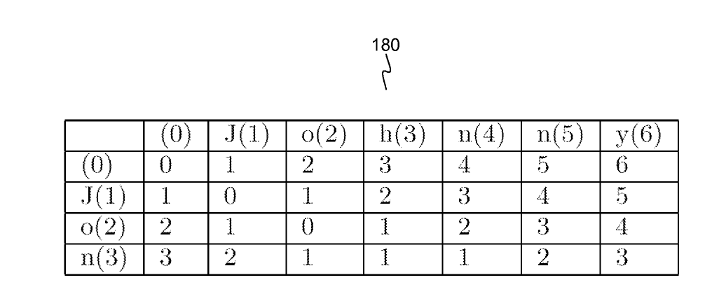

Suppose that the two strings under consideration are s1 and s2. Place the two strings on a matrix D with si top-down and s2 left-to-right, and incrementally compute the edit distance between all prefixes of s1 and s2. FIG. 3 shows the dynamic programming matrix 180 for the two strings s1=“Jon” and s2=“Johnny”. Let i be the index of the rows in the dynamic programming matrix and j be the index of the columns. The row numbers increase downward whereas the column numbers increase from left to right. Both begin at 0. The numbers in parentheses in matrix 180 indicate the row and column numbers. The number entered in cell D(i, j) denotes the edit distance between the prefixes ending at i and j respectively. The recurrence relation that completes D is as follows:

D(l,j)=min(D(i−1,j)+1,

D(i,j−1)+1,

D(i−1,j−1)+δ(i,j))

where δ(i, j) is 0 or 1 according as the i-th character of s1 and the j-th character of s2 are equal. For example, D(“Jo”, “Joh”)=D(2,3)=min(D(1,3)+1 ,D(2, 2)+1, D(1, 2)+δ(2, 3))=min(3, 1, 2)=1.

Note that in this process, the edit distance between s1 and all prefixes of s2 is found—this is captured in the last row of D. The prefix of s2 can then be found with the smallest edit distance from s1 by finding the smallest entry in the last row. Using Property 1, it can be seen that this yields the extension distance. It can be seen from matrix 180 that even though the edit distance is 3, the extension distance is 1 for s1 and s2 as defined above.

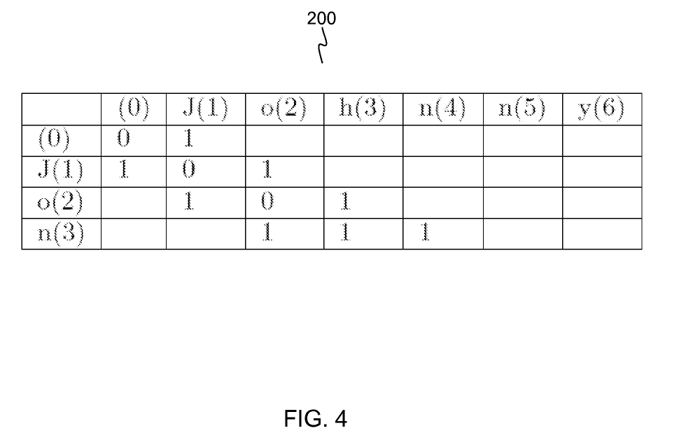

Now consider the k-Extension Distance problem. Parts of the matrix D can be ignored where the value is guaranteed to be larger than k. The following property of matrix D follows from the recurrence relation and formalizes the previous observation. Property 2. (1) D(i, 0)=i and D(0, j)=j, and (2) D(i, j)≧D(i−1, j−1). Now the c-diagonal is defined to be all cells such that i−j=c (c may be negative). By Property 2, it follows that it is sufficient to track the entries of D in diagonals −k through k; all other cells in D should have values larger than k. For each cell in these diagonals, the edit distance is stored if it is at most k (otherwise 1 is stored). The recurrence relation can be used to compute the edit distance so long as it is at most k. The minimum value in the last row is read off as before to compute the extension distance. FIG. 4 shows a matrix 200 for the case where k=1. Observe that this algorithm takes O(kn) time where n is the length of s1.

Finally, it can be seen that the above algorithm is naturally incremental. Adding a new character to s1 corresponds to adding a new row to the matrix D. By the form of the recurrence relation, it can be seen that the old entries of D do not change and that the 2k+1 entries for this row can be computed from the old entries of D in constant time per new entry.

### Baseline Algorithm for Edit-Tolerant Autocompletion

Property 1 may be coupled with any offline edit distance matching algorithm to implement both the Full and Buffered strategies. Some notation will first be introduced to talk about the prefixes of strings.

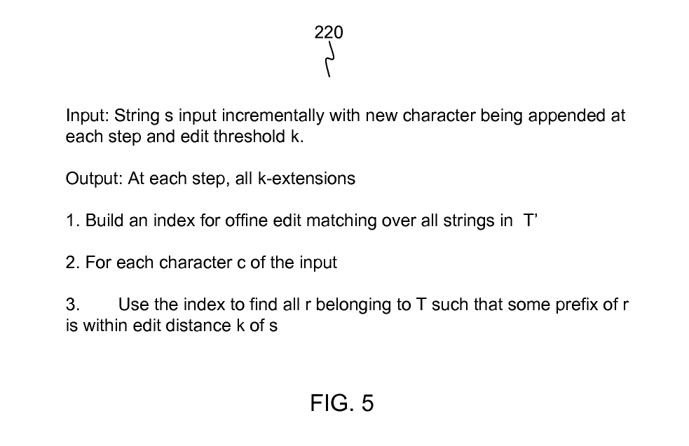

Given a string r, the set consisting of r and all of its prefixes is denoted r. Given a table of strings T, the set of strings in T along with all their prefixes is denoted T′. All strings in T′ are indexed. At any point in the autocompletion, the offline algorithm is invoked to find matching strings in T′ and then return their corresponding extensions. This will be referred to as the baseline algorithm, which is sketched in algorithm 220, shown in FIG. 5. Algorithm 220 can be trivially extended to handle the Buffered strategy. Algorithm 220 may be improved by exploiting (1) the structure of the set T′ that is being indexed, and (2) the commonality among the successive lookups which only differ by one character. The next two sections, Q-gram Based Algorithm and Trie-based Algorithm show how this may be done.

### Q-Gram Based Algorithm

Q-gram based techniques constitute the state-of-the-art algorithms for offline edit distance matching, and full details may be found elsewhere. Nonetheless, these algorithms will be briefly reviewed before describing extensions for autocompletion.

A q-gram of a string s is a contiguous substring of s of length q. The q-gram set is the bag of all q-grams of s. If the edit distance between two strings s and r is small, then the overlap between the corresponding q-gram sets should be large. Formally if ed(r, s)≦k then the (bag) intersection between their q-gram sets should be at least (max (|r|, |s|)−q+1)−q.k where |r| and |s| denote the lengths of r and s respectively. For example, the edit distance between “shwarzenegger” and “schwarzenegger” is 1. Consider their 1-gram sets which is the set of all characters in the strings. Their intersection size is 13 which is larger than or equal to (max(13, 14)−1+1)−1.1=13.

This relationship is used to invoke a set-similarity based matching. The detail of set-similarity matching that is relevant here is that most previously proposed algorithms are based on signature schemes. The idea is to create a set of signatures for each string based on its q-gram set. The signature scheme must have the property that whenever two strings have edit distance within k, they share at least one common signature. Examples of signature schemes are Prefix-Filter, PartEnum, and Locality Sensitive Hashing, each described elsewhere. The index consists of an inverted list that maps a signature to all strings that generate this signature. At lookup time, signatures are generated for the lookup string and the union of all the corresponding rid-lists is taken. Each string in this union is then passed through a verification to check whether its edit distance to the lookup string is indeed within k. This verification step is used because the signature lookup can generate false positives.

Q-gram based autocompletion will now be described. First, a signature scheme Sig is fixed. Consider a string r ε T. From Property 1 it may be helpful to consider returning r whenever some prefix of r is within edit distance k of the lookup string.

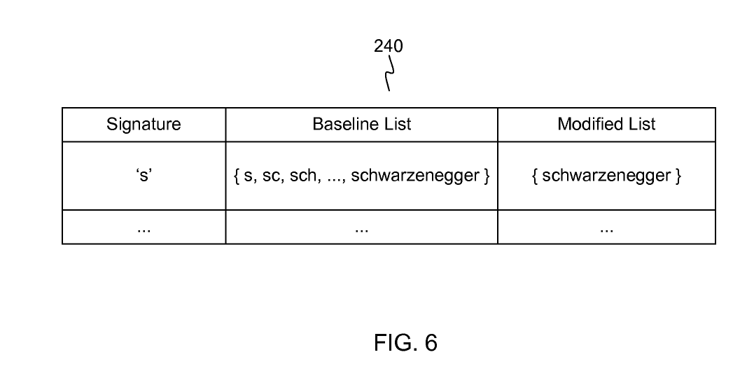

The problem of using the q-gram approach coupled with the baseline algorithm 220 will now be illustrated with an example. Suppose that T consists of the single string r=“schwarzenegger”. Suppose also that the signature scheme Sig returns all 1-grams. There is one inverted list per character of the string “schwarzenegger”. Each of these lists contains all prefixes of r that contain the respective character. For instance, the list for character ‘s’ contains all prefixes of r. This is shown in the column called “Baseline List” in table 240 of FIG. 6. Now consider the lookup string “shwarz”. Under the baseline algorithm, each string in the inverted list of ‘S’ is verified. Thus, invoke the k-Extension Distance algorithm, discussed below, is invoked for every prefix of the string “Schwarzenegger”.

This may be improved as follows. The signature scheme is modified to obtain signature scheme Sig′ where Sig′(r)=∪ᵣ′ε ᵣSig(r′). Since the strings in r have substantial overlap, they generate many common signatures. Unlike the baseline approach, these common signatures are represented only once. An inverted index is built over the signatures generated by Sig′. The inverted index for the character ‘s’ in the example above consists of the single string “Schwarzenegger”. This is shown in table 240 in the column marked “Modified List”.

The verification phase can be optimized by exploiting the commonality among the strings in r. As noted in the “Properties of k-Extensions” section, the k-Extension Distance computation between r and s actually performs the k-Extension Distance computation for all pairs of strings in r, s. By Property 1, verification can be performed in one invocation of the dynamic programming algorithm described in the “Properties of K-Extensions” section.

The q-gram based algorithm can be further optimized by exploiting the fact that successive lookup strings only differ in one character. At each step, it is possible to avoid re-scanning the lists of signatures that have already examined. For example, because the signatures for “sh” and “shw” contain the character ‘s’, the list for ‘s’ is accessed only once.

These optimizations lead to significant improvements in the running time of the q-gram based algorithm. However, despite these optimizations, the number of strings being retrieved at each step for verification can be significant leading to poor performance. It may be helpful to “transition” from the results in one step to the results in the next. This may be accomplished in an automaton-style traversal over a trie, as described next.

### Trie-Based Algorithm

We now discuss our trie-based autocompletion algorithms. As mentioned in Section 4, the idea is to transition from the k-extensions in one step to the next just as is done in an automaton. This also results in a novel algorithm for offline edit distance matching that, to the best of our knowledge, is unlike all previously proposed algorithms that perform edit distance matching using a trie [18] in that it processes the lookup string character by character (see Section 7 for a detailed discussion of related work). 5.1

### Full K-Extension Strategy

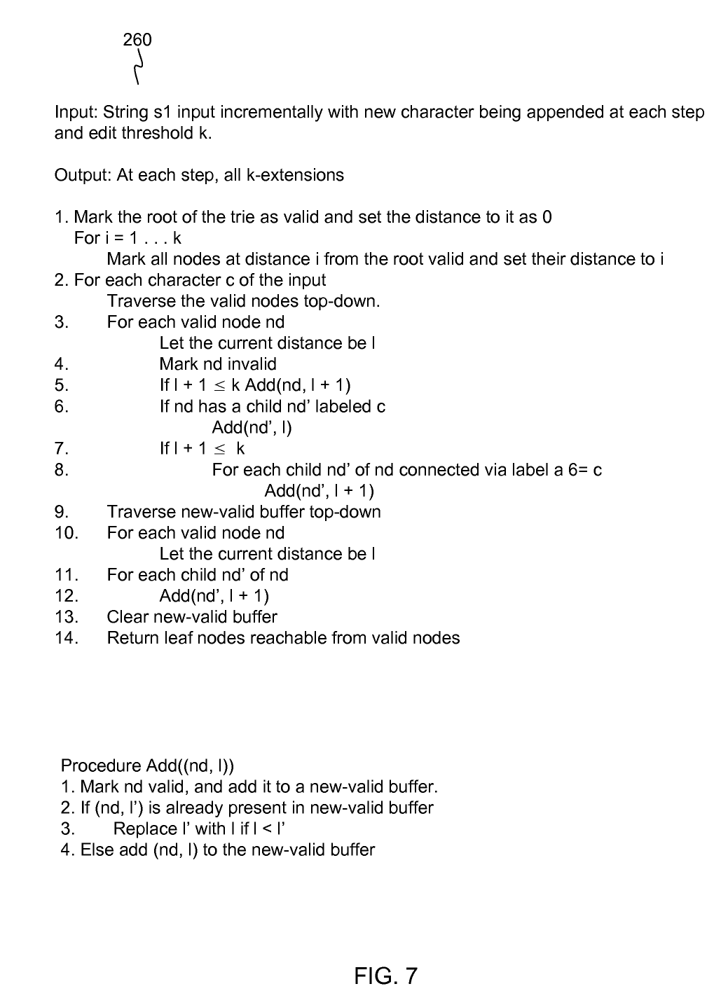

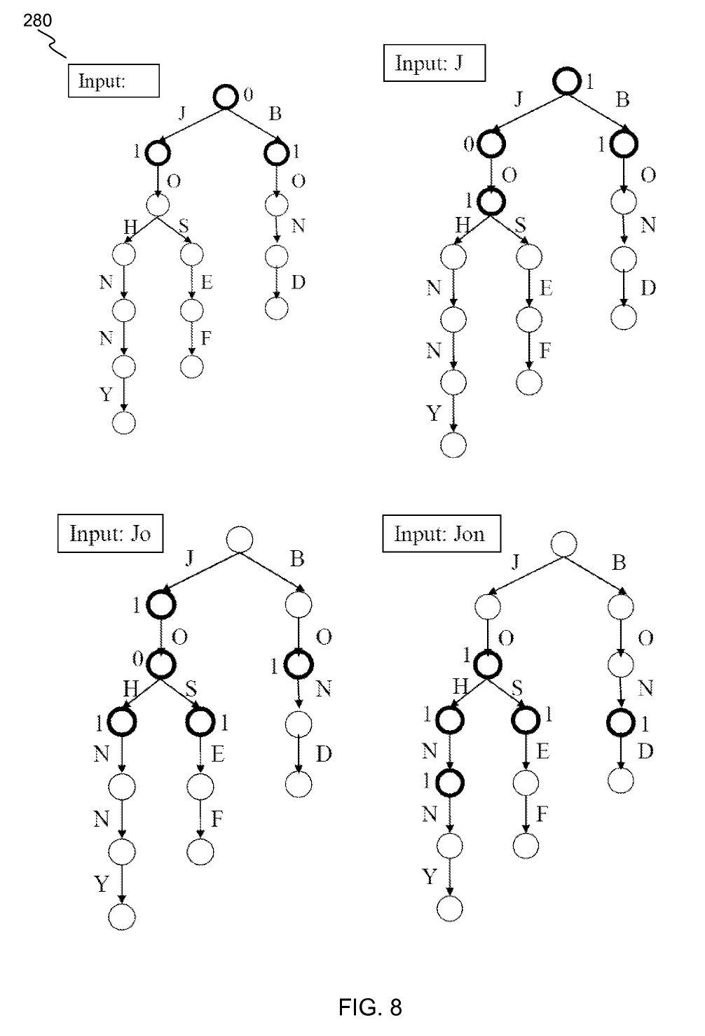

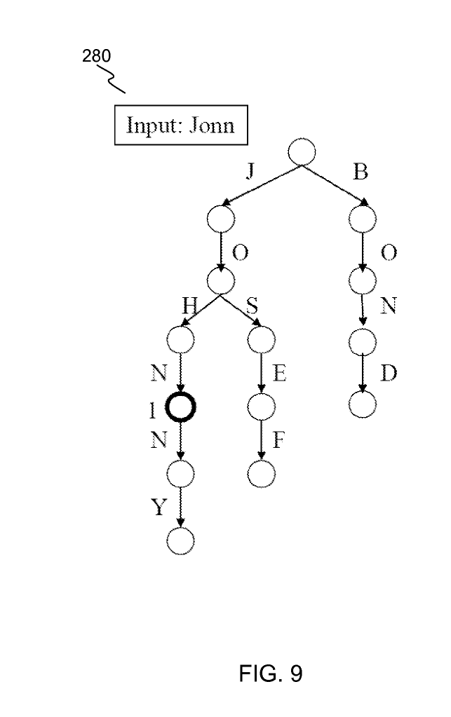

The set of strings in T may be organized as a trie. The transitions are represented as edge labels. FIG. 7 shows a trie-based algorithm 260. FIGS. 8 and 9 show an example trie.

Owing to potential edit errors at any given time, it may be possible to be at multiple nodes in the trie. The algorithm 260 maintains the set of all prefixes of the strings in the database that are within edit distance k. The corresponding nodes in the trie are deemed valid. It can be shown that for any k-extension of the lookup string, there at most 2k+1 prefixes that are within distance k, and that these prefixes correspond to a contiguous path in the trie.

When the next character is appended to the input, transitions are made roughly corresponding to how the edit matrix is populated. The input string may be thought of as populating the rows of the edit matrix D. Before the next character is appended, the values for row i are populated. Recall that cell D(i, j) influences the values in D(i+1, j), D(i, j+1) and D(i+1, j+1). Of these three cells, two are in row i+1, which is being populated. In the trie, this corresponds to two moves: for each node its distance is incremented, and for each child of the node the distance is appropriately set based on whether the edge label agrees with the input character or not. Steps 5-8 in algorithm 260 illustrate this. Marking a node valid is considered only if the edit distance is at most k. Further, since it is possible to reach a cell in multiple ways, the minimum distance (Procedure Add) is tracked.

The impact of a cell on its neighbor in the same row is captured in steps 10-12 of algorithm 260. The updated distances are used to perform this step. Further, this propagation should happen left-to-right in the edit matrix. In the trie, this corresponds to going top-down. Thus the nodes are propagated top-down (Step 9 of algorithm 260). The algorithm 260 is initialized for the empty input string. This corresponds to going top-down. Thus the nodes are propagated top-down (Step 9, algorithm 260). The algorithm 260 is initialized for the empty input string. This corresponds to marking the root and all nodes reachable within distance k from the root as valid (Step 1, algorithm 260). Finally, just as for the exact case, all leaf nodes reachable from the valid nodes are returned. Note that the edit distance ordering can be ensured by sorting the node distances before retrieving the leaf nodes reachable from them.

FIGS. 8-9 show tries 280 that demonstrate how the algorithm 260 operates on a table or database consisting of three strings: “Johnny”, “Josef”, and “Bond”. The input string being entered is “Jonn”. At each step, the valid nodes are shown in bold with their distances shown beside them.

### Buffered K-Extension Strategy

The full-extension strategy described above may have some inefficiency because the number of valid nodes can be large. For instance, when the input string is empty, all nodes that are within distance k of the root of the trie are deemed valid. For a test case, how the number of valid nodes changes with progress in the lookup string was studied empirically. Working with an address data set consisting of 100 thousand strings, lookup strings were selected at random from the same database and the average number of valid nodes at any given position was computed for various edit distance thresholds. Results showed that the number of valid nodes arose sharply with the edit distance threshold reaching a maximum of close to 25% of the number of strings in the data for k=4, but also dropped quickly once some initial portion of the string had been processed. This sharp increase in the number of valid nodes can lead to an increase in execution time. Thus, a buffered autocompletion strategy may be considered.

To use algorithm 260 to support this strategy, a technique may be used to determine the set of valid nodes at the transition length. This may be accomplished by maintaining a separate index and invoking an offline edit distance matching algorithm at the transition length. For example, any of the q-gram based algorithms could be used. However, it was found empirically that these may not perform well when string lengths are short.

On the other hand, the fact that the transition length is small can be used to pre-compute edit distance matches. The alphabet size is reduced by hashing all characters to a small number of bits. Note that in this process, it may be the case that the edit distance between two strings can only decrease. In this hashed space, the number of strings of a small length is not very large. For instance, all characters to 4 bits are hashed and a transition length of 5 is considered, the number of possible hashed strings is 1 million. For each of these, all distance k neighbors from T are pre-computed. Note that at lookup time, the strings returned from pre-computation may be verified to check whether they are within edit distance k in the original alphabet space (this can be achieved via the dynamic programming algorithm described above).

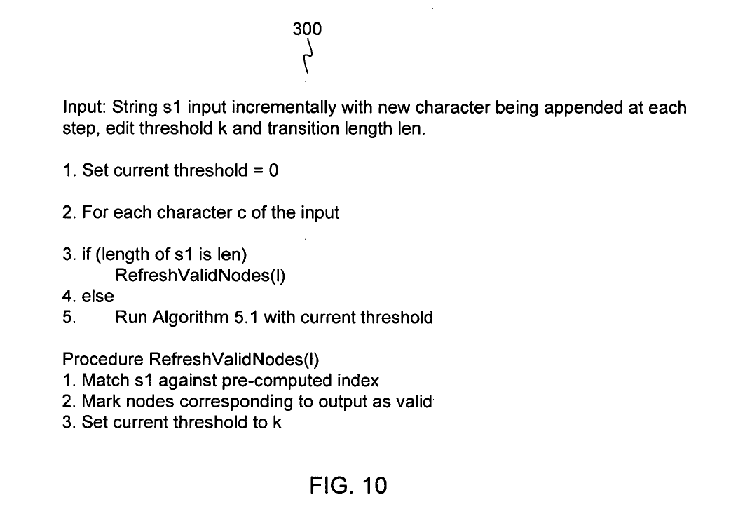

From empirical study, the number of valid states drops sharply as the transition length increases. FIG. 10 shows an algorithm 300 for setting an appropriate transition length, where pre-computation is used to overcome the problem with short strings.

### Top-N Semantics

As noted above, extensions even can be ordered via a static score associated with each string in T. This ordering can be used to return only the top-n extensions. This further helps in keeping the output size small. In the presence of string edits, there is a similar option of returning only the top-n extensions sorted by a ranking function Score( ) which combines the edit distance with the static score of a string in a monotonic fashion (as described earlier). Finding all extensions and then sorting them by their score can be inefficient because the number of extensions can be large, although only the top-n should be returned. To address this possibility, the top-n completions may be pre-computed by static score for each node in the trie. For exact autocompletion, this may be used to read off the top-n extensions from the current node in the trie. When allowing for edits, there may be multiple valid nodes in the trie. Therefore the sorted lists corresponding to each valid node may be merged to obtain the overall top-n. Since the overall score is preferably monotonic in the static score and the edit distance, it is possible to invoke any previously known algorithms that perform early termination when computing the top-n results (e.g., R. Fagin, A. Lotem, and M. Naor, “Optimal aggregation algorithms for middleware”, PODS, 2001). This can also be used in the embodiments of the q-gram based algorithms by treating the q-gram technique as a way of obtaining the valid nodes in the trie at each step.

### Miscellaneous Implementation Details

To implement a trie in memory, it is suggested to store a separate table of the top-n completions at each node on a separate in-memory table. The set of active nodes may be handled as a queue, to which nodes are added and processed in level order. Note that this is different from the buffered strategy due to effects on the edit-distance based semantics.

### Conclusion

Embodiments and features discussed above can be realized in the form of information stored in volatile or non-volatile computer or device readable media. This is deemed to include at least media such as optical storage (e.g., CD-ROM), magnetic media, flash ROM, or any current or future means of storing digital information. The stored information can be in the form of machine executable instructions (e.g., compiled executable binary code), source code, bytecode, or any other information that can be used to enable or configure computing devices to perform the various embodiments discussed above. This is also deemed to include at least volatile memory such as RAM and/or virtual memory storing information such as CPU instructions during execution of a program carrying out an embodiment, as well as non-volatile media storing information that allows a program or executable to be loaded and executed. The embodiments and features can be performed on any type of computing device, including portable devices, workstations, servers, mobile wireless devices, and so on.

1. A method implemented on a computing device for performing error-tolerant autocompletion, the method comprising:
receiving an input string interactively inputted by a person;
accessing a table of strings stored in memory of the computing device and evaluating the strings in the table by determining, for each string, if the string satisfies a condition of containing a prefix of the input that is within a threshold edit distance of the input string; and
displaying to the person one or more of the strings of the table determined to satisfy the condition.

2. A method according to claim 1, wherein the determining is performed by an error-tolerant string prefix matching algorithm.

3. A method according to claim 1, the determining comprises computing edit distances between the input string and prefixes of strings in the table.

4. A method according to claim 3, wherein the determining comprises using a q-gram based algorithm to compute the edit distances.

5. A method according to claim 4, wherein the q-gram based algorithm computes signatures for the strings in the table based on q-gram sets of the strings.

6. A method according to claim 1, wherein the determining comprises representing strings in the table as tries where nodes of the tries comprise characters of the strings.

7. One or more computer-readable storage media storing information to enable a computing device to perform a process, the process comprising:
while displaying characters of an input string as they are inputted by a user, when a character is added to the input string by the user, selecting matching strings from among a set of candidate strings by determining which of the candidate strings have a prefix whose characters match the characters of the input string, where the determining selects candidate strings that have a prefix that inexactly matches the input string.

8. One or more computer-readable storage media according to claim 7, wherein the selecting comprises using an edit distance function to determine whether a candidate string is within an edit distance greater than 0 and less than a threshold value.

9. One or more computer-readable storage media according to claim 7, further comprising determining whether to perform autocompletion based on a string length of the input string.

10. One or more computer-readable storage media according to claim 7, further comprising displaying one or more selected candidate strings and setting the input string to one of the displayed candidate strings when the candidate string is interactively selected by the user.

11. One or more computer-readable storage media according to claim 7, wherein the determining which of the candidate strings have a prefix whose characters match the characters of the input string comprises determining if a minimal edit distance between a prefix of a candidate string and the input string is within a threshold.

12. One or more computer-readable storage media according to claim 11, wherein when the minimal edit distance is within the threshold, selecting the candidate string as an autocompletion candidate for the input string, wherein the candidate string has a prefix that is not equal to the input string but can be transformed to the input string by a number of edits that is within the threshold.

13. One or more computer-readable storage media according to claim 7, further comprising ranking a plurality of selected candidate strings according to a scoring function.

14. One or more computer-readable storage media according to claim 7, wherein the selecting is performed by a q-gram based algorithm for computing edit distance between two strings.

15. One or more computer-readable storage media according to claim 7, wherein the selecting is performed by a trie-based algorithm that processes the input string character by character as new characters are added to the input string, wherein the characters of the candidate string are represented as corresponding nodes in a trie.

16. A computing device configured to perform a process, the process comprising:
a text input area displayed on a display and into which a user uses an input device to interactively form an input string;
memory storing a table of strings;
a processor performing autocompletion on the input string by, each time the input string is modified by the user in the text input area, analyzing the table of strings and selecting therefrom a set of strings based on the strings having a prefix that is within an edit of the input string, where the edit distance is greater than zero and one or more of the selected strings have a prefix that comprises an inexact match of the input string.

17. A computing device according to claim 16, wherein the selecting comprises selecting input strings having k-extensions of the input string, where k is greater than zero.

18. A computing device according to claim 16, wherein an edit-tolerant substring matching function, including a suffix trie, performs the selecting.

19. A computing device according to claim 16, wherein the selecting is performed each time the user appends a character to the input string, strings are selected but not displayed while the input string is less than a given length, and strings are selected and displayed when the input string is greater than the given length.

20. A computing device according to claim 16 wherein the selecting is performed using an error-tolerant prefix matching function.
